(19) United States
(12) Patent Application Publication
(10) Pub. No.: US 2015/0253902 A1
(43) Pub. Date: Sep. 10, 2015

(54) STRUCTURE AND THE ASSOCIATED MANUFACTURING PROCESS FOR A SINGLE-SIDED MULTI-LAYER MUTUAL CAPACITANCE TOUCH PANEL

(71) Applicant: CN Innovations Limited, Hong Kong (CN)

(72) Inventor: Winston CHAN, Hong Kong (CN)

(21) Appl. No.: 14/623,178

(22) Filed: Feb. 16, 2015

Related U.S. Application Data
(60) Provisional application No. 61/949,247, filed on Mar. 7, 2014.

(51) Int. Cl. G06F 3/044; G06F 3/045

(52) U.S. Cl. CPC G06F 3/044; G06F 3/045; G06F 2203/04104; G06F 2203/04103

(57) ABSTRACT

A structure for a mutual capacitance touch panel consists of two conducting layers formed on the same side of a non-conducting substrate, insulating gaps within the structure, and insulating blocks formed between the two conducting layers for electrical isolation. This structure relies on the insulating gaps to form a touch function circuit in the first direction, a first auxiliary touch function region on the first conducting layer, a second touch function circuit in the second direction, and a second auxiliary touch function region on the second conducting layer. The insulating blocks are arranged at intersecting points of the first and second conducting touch function circuits that electrically isolate the first and the second conducting circuits. This structure is achieved by using a simple manufacturing process with a high yield but low material consumption thereby allowing a novel touch function structure to be implemented.

### RELATED APPLICATION

This application claims priority to U.S. Provisional Application Ser. No. 61/949,247 filed on Mar. 7, 2014, the contents which are hereby incorporated by reference in their entirety.

### FIELD OF THE INVENTION

The present subject matter relates to the field of electronics and, more particularly, to the field of touch panels based on a mutual capacitance sensing approach, and associated manufacturing methods, device structures and designs.

### BACKGROUND OF INVENTION

With rapid development in the market for information and electronic products, and the ever-increasing demand from customers for intelligent, convenient, and easy-to-use electronic products, touch panels have a profound and widespread application, as touch panels have an intuitive input interface. Currently, major capacitive touch panels include inductive capacitive touch panels and surface capacitive touch panels. Both touch panel types are mainly used in personal portable products, industrial products, products for public information inquiry, and educational purposes.

With the continuous increase in the market for electronic products, as well as more demanding requirements for intelligent and user-friendly mobile phones, touch panels provide a direct interface and become more and more popular for mobile phone applications. From a technical point of view, touch panels are classified into five categories, namely vector pressure sensor touch panels, resistive touch panels, capacitive touch panels, infrared touch panels, and surface acoustic wave touch panels. Among these different panels, capacitive touch panels provide the most rational design, as they support a multi-touch input on the panel surface. The touch position of a capacitive touch panel is accurately located even if there is dirt, dust, or grease on the surface of the panel. As the optical transmittance, operating temperature, customers' comments, accuracy and reliability of capacitive touch panels are superior to other devices, capacitive touch panels are an indispensable device for personal electronic products.

In order to accurately locate the touch position of a finger or a stylus pen on a touch panel and with the increasing demand from customers for thinner and lighter products, the industry has developed various technologies for capacitive touch sensing and the overlay structure. In U.S. Pre-Grant Publication No. 2008/0309633 A1, a dual indium tin oxide (DITO) structure of a capacitive touch panel is described. A conducting layer is formed on each side of the glass substrate. On one side of the glass substrate, a first direction touch circuit is formed, while a second direction touch circuit is formed on the opposite side of the glass substrate. The two touch circuits are completely separated by the glass substrate and the touch function is realized by the distance between the capacitors. However, this design is often limited by the thickness of the substrate and difficult to use in producing thinner products.

In Chinese Patent No. 201078769 Y, a single-sided bridging touch structure is described. The conducting group along a first axis and another set of conducting components along a second axis are both formed on a single conducting layer. By having an insulating layer and small wires to connect the components along the second axis, these components form the second conducting group to realize the touch function. In order to form these local connection wires, a complicated process is required but the product yield is low. The process also requires a large amount of conducting materials and generates a large amount of chemical waste. Therefore, it is not an economical and environmentally friendly process for touch panel manufacture.

In U.S. Pre-Grant Publication No. 2010/0258360 A1, a single-layer, multi-touch structure is described. A touch circuit is formed by a single conducting layer and used to create a multi-touch function device. This subject matter allows thin and light touch panels to be manufactured at the expense of touch sensing performance. Further, the manufacturing yield based on this subject matter is relatively low for touch panels in larger dimensions.

The current subject matter allows production of thin and light weight touch panels. Moreover, it offers high accuracy and precision of a touch position and a superior response speed compared to other devices. Further, the present subject matter has obvious advantages in manufacturing touch panels of large dimensions.

### SUMMARY

The present subject matter provides a thin touch function structure, that is achieved with an easy-to-implement, cost-effective and environmentally friendly manufacturing process. This touch function structure is better than devices disclosed in the prior art according to the following advantages: (i) a thinner touch panel is manufactured, without compromising the precision, sensitivity, and dimensions of the typical single-layer multi-touch touch panel structure; and (ii) the problems associated with the conventional process for manufacturing a single-layer and bridging the touch structure of a complicated design with a low yield, consuming a large amount of conducting materials, and generating a large amount of waste is overcome by a significantly simplified and improved touch function structure and method thereof, as provided by the present subject matter.

The touch function structure provided by the present subject matter comprises two thin and high surface resistance conducting touch function layers that cover the entire substrate. Between the two conducting layers, thin insulating blocks and gaps are arranged. A conducting touch circuit in the first direction (denoted as X) and its auxiliary touch function region are formed on the first conducting touch function layer; while the conducting touch circuit in the second direction (denoted as Y) and its auxiliary touch function region are formed on the second conducting layer, thereby completing the second conducting touch function layer. The insulating blocks are located at the intersecting points of the two conducting touch function circuits and electrically isolate the first direction conducting circuit from the second direction conducting circuit.

When compared with the dual indium tin oxide (DITO) structure which consists of two touch function layers and one thin insulating layer, the present subject matter discloses the use of insulating blocks sandwiched between two touch function layers that significantly reduce the thickness of the capacitive touch panel and also reduce chemical consumption.

When compared with the single-sided bridging touch structure which consists of one touch function layer, one disconnected insulating layer, and a conduction bridge (low surface resistance), the present invention discloses the use of two touch function layers (high surface resistance) and insulating blocks, that significantly reduce the complexity of the manufacturing process. The two touch function layers and insulating blocks also reduce the consumption of conducting chemicals required for the manufacture of bridges, and at the same time reduce waste generation. Furthermore, the present subject matter provides an environmentally friendly process for manufacturing a capacitive touch structure.

When compared to the single-layer and multi-touch structure, the present subject matter ensures that thin and light weight touch panels are manufactured. The accuracy and precision of the touch position and the response speed of touch sensing are superior to the capacitance devices found in current prior art. The advantages of the present subject matter are even more pronounced and significant for manufacturing touch panels of large dimensions.

While the key components and concepts of the present subject matter are disclosed, other embodiments are apparent to those skilled in the art from the following detailed description, which shows and describes an illustrative embodiment of the disclosure. The present subject matter is capable of modifications in various obvious aspects, all without departing from the spirit and scope of the present subject matter. The drawings and detailed descriptions provided herein are illustrative in nature and concept, and should not impose any restriction.

### BRIEF DESCRIPTION OF DRAWINGS

FIG. 1 shows an example of cross-sectional views of the novel touch function structure.

FIG. 2 shows the first conducting touch function layer and an example of the touch circuit for the present subject matter.

FIG. 3 shows an illustration of the isolated insulating patches in this novel subject matter.

FIG. 4a shows the second conducting touch function layer and an example of the touch circuit for the present subject matter.

FIG. 4b shows the auxiliary touch function circuits on the first conducting touch function layer and on the second conducting touch function layer, insulating blocks, and insulating gaps on the first conducting touch function layer and on the second conducting touch function layer.

FIG. 5 shows the schematic diagram of a touch function circuit example formed in this novel subject matter of two conducting touch function layers and various insulating patches.

FIG. 6 shows the schematic diagram of a touch function circuit example in the present subject matter.

FIG. 7 shows an example of the top view of the novel touch function structure

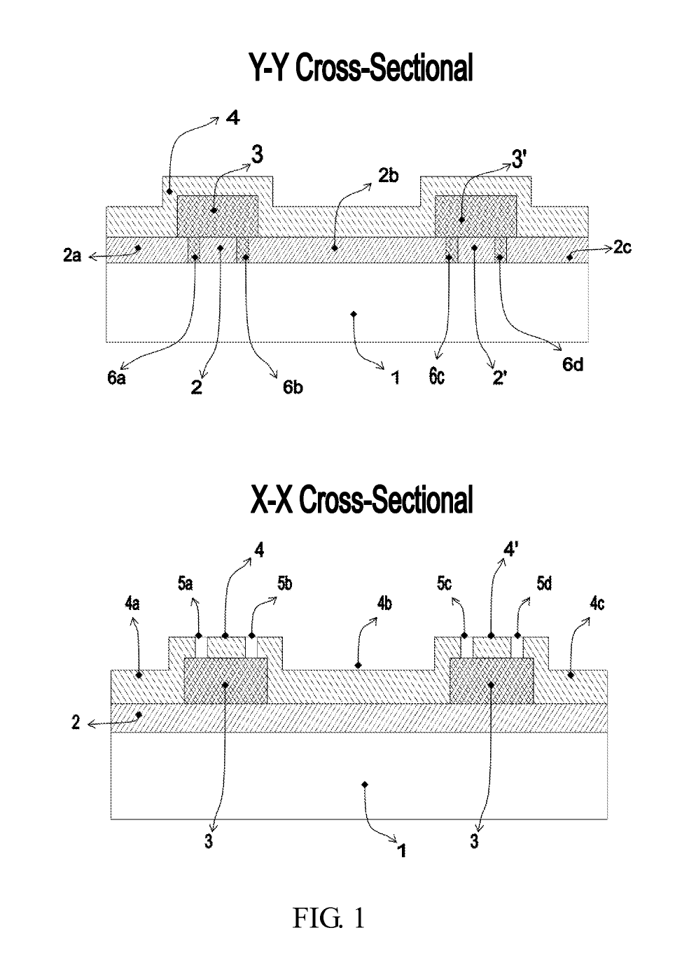

The features of FIGS. 1-7 are listed below by reference numeral:
1: Substrate.
2, 2′: The touch function circuit in X on the first conducting touch function layer.
2a, 2b, 2c, 2a′, 2b′, 2c′: Auxiliary touch function circuits on the first conducting touch function layer.
3, 3′: Isolated insulating blocks.
4, 4′: The touch function circuit in Y on the second conducting touch function layer.
4a, 4b, 4c, 4a′, 4b′, 4c′: Auxiliary touch function circuits on the second conducting touch function layer.
5a, 5b, 5c, 5d, 5a′, 5b′, 5c′, 5d′: The insulating gaps on the second conducting touch function layer.
6a, 6b, 6c, 6d, 6a′, 6b′, 6c′, 6d′: The insulating gaps on the first conducting touch function layer.
6a, 6b, 6c, 6d+5a, 5b, 5c, 5d: The insulating gaps of the contact area of the first and second conducting touch function layer.
6a′, 6b′, 6c′, 6d′+5a′, 5b′, 5c′, 5d′: The array of the insulating gaps of the contact area of the first and second conducting touch function layer.
7: Metal leads.
8: Mutual capacitance finger touch detection generated by the first direction and the second direction touch function circuits.

### DETAILED DESCRIPTION

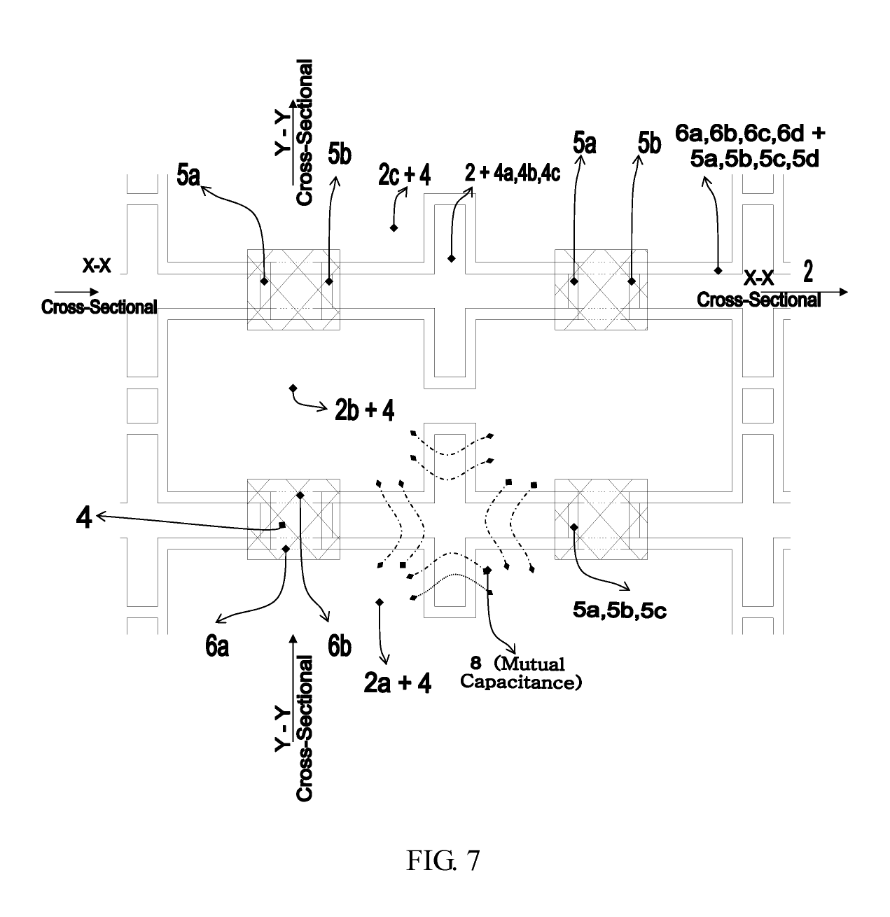

The present subject matter is directed to a touch function structure, and an associated manufacturing process for the making of single-sided, multi-layer, mutual capacitance touch panels for electronic devices, as shown in FIG. 7.

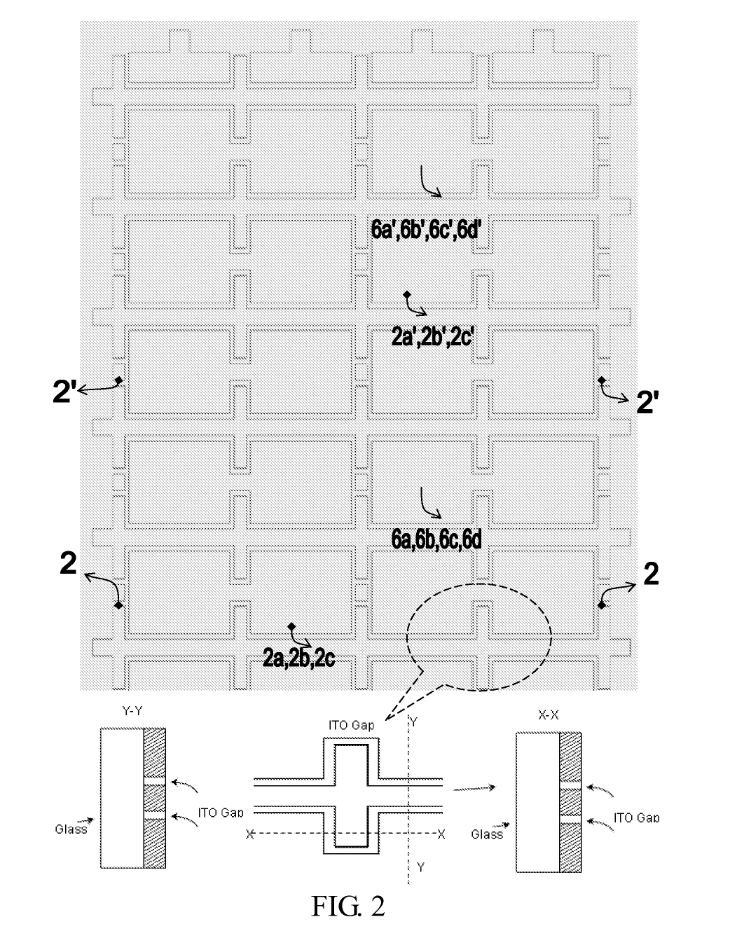

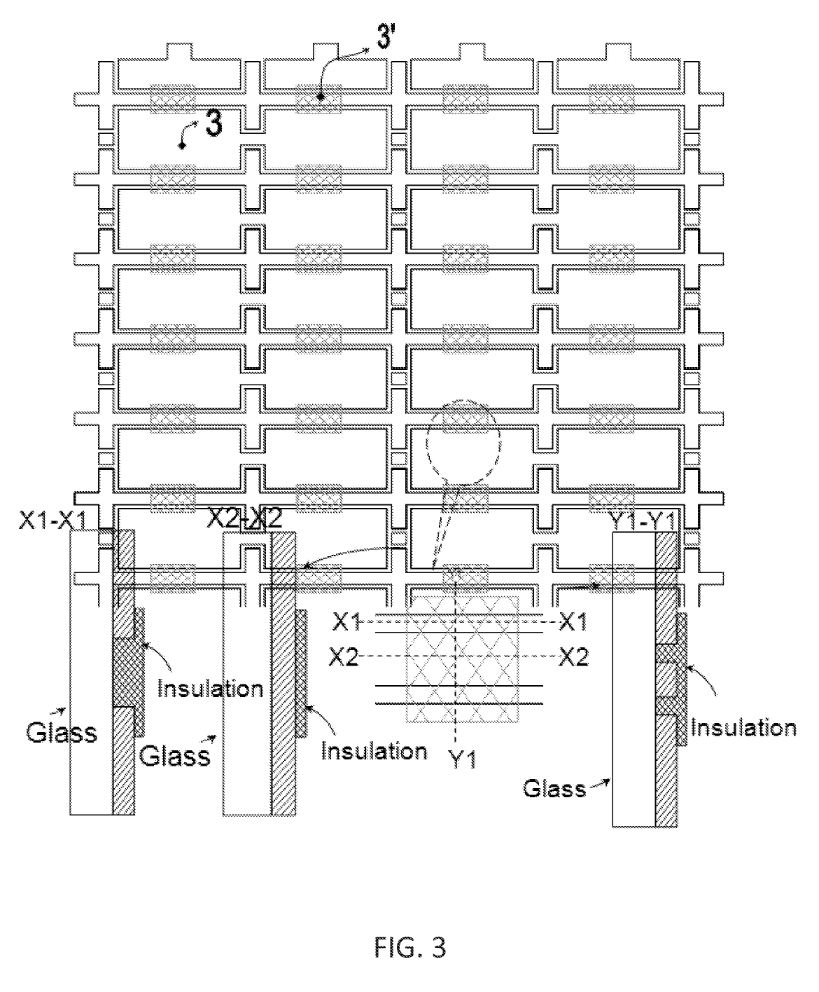

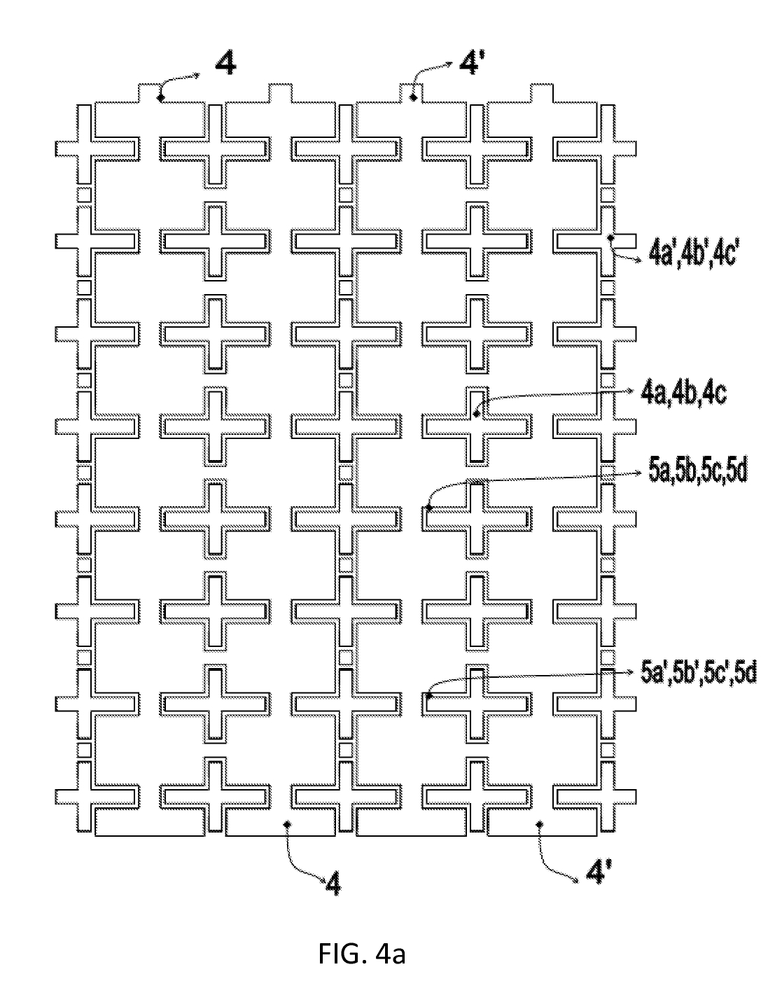

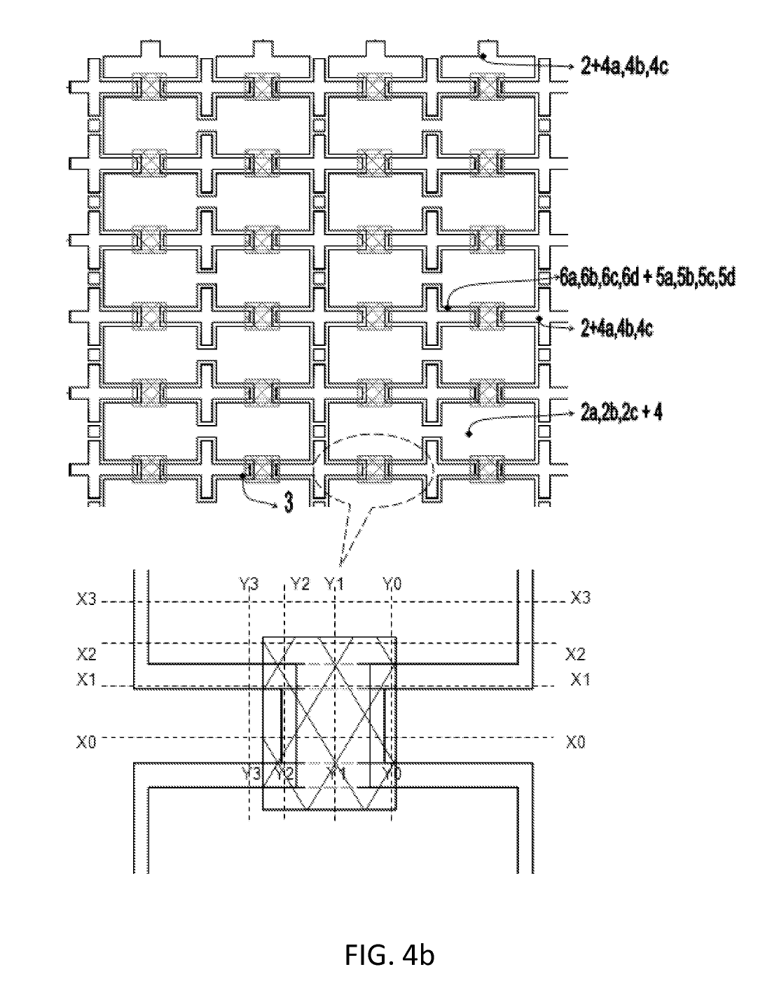

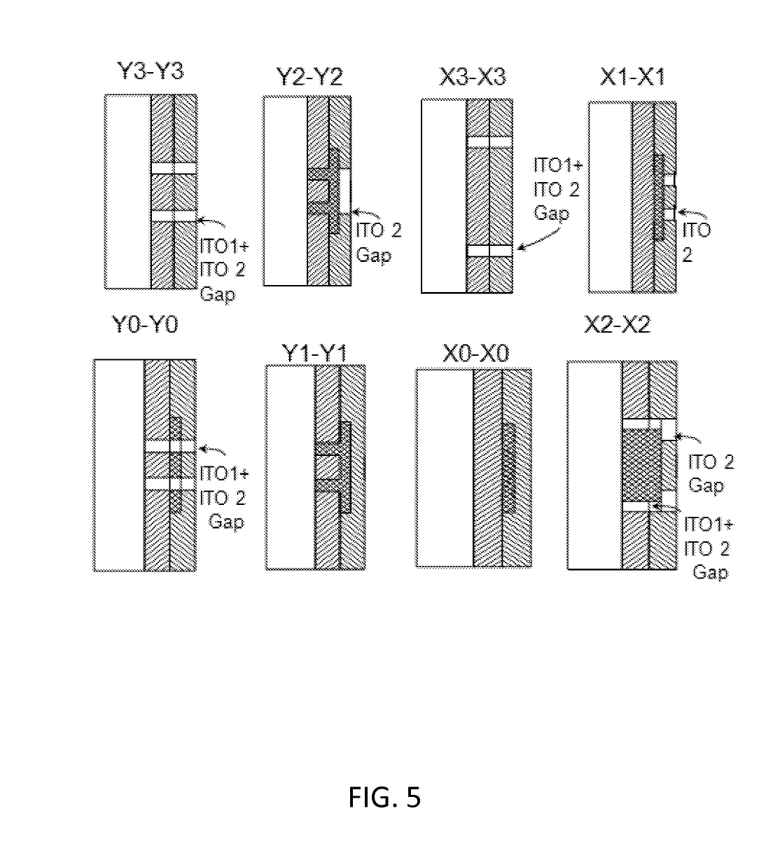

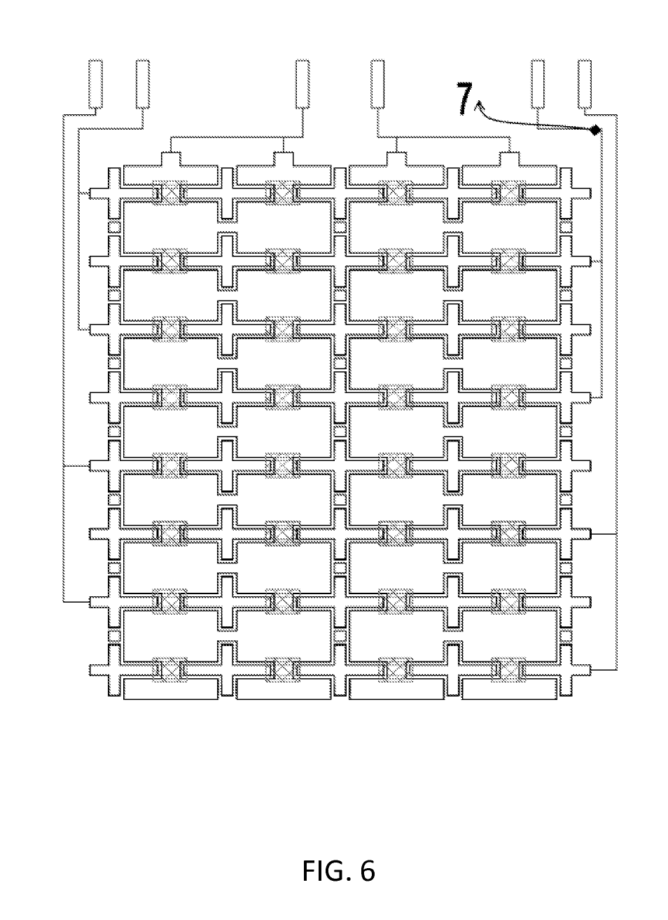

The present subject matter includes two thin and high surface resistant conducting touch function layers that cover the entire substrate. Between the two conducting layers, there are thin insulating blocks, as shown in FIG. 1. Relying on the insulating blocks and the insulating gaps, the conducting touch circuit in X and auxiliary touch function regions are formed on the first conducting touch function layer, as shown in FIG. 2, while the conducting touch circuit in Y and auxiliary touch function regions are formed on the second layer, thereby completing the conducting touch function layer in its entirety, as shown in FIG. 4. X and Y are generally arranged orthogonally, although other geometry is allowed if the geometry does not depart from the spirit and scope of the present subject matter. The insulating blocks are located at the intersection points of the circuits in X and Y formed by common areas of the first conducting touch function circuit and the second conducting touch function circuit, and electrically isolate the first direction conducting circuit from the second direction conducting circuit at the intersection points, as shown in FIG. 3, FIG. 5, and FIG. 6.

The touch function structure of the present subject matter is achieved by touch function circuits on the first and second conductive touch function layers, respectively. The touch function structure primarily relies on forming the first direction touch function circuit and the second direction touch function circuit on the first conduction touch function layer and the second conduction touch function layer, respectively. Generally, the auxiliary touch function region of the first conductive touch function layer enhances the second direction touch function circuit characteristics, while the auxiliary touch function region of the second conductive touch function layer enhances the first direction touch function circuit characteristics. As shown in FIG. 1, the auxiliary touch function region of the first conductive touch function layer enhances touch function characteristics in Y, while the auxiliary function regions of the second conductive touch function layer enhances the touch function characteristics in X.

Along X, the insulating blocks are located in between the auxiliary touch function region of the second layer and complete the second conductive touch function layer; while the touch function circuit on the first layer remains connected, as shown in FIG. 1. Along Y, the insulating blocks are located in between the auxiliary touch function region of the first layer and complete the first conductive touch function layer; while the touch function circuit of the second layer remains connected, as shown in FIG. 1.

In a non-limiting embodiment, the substrate is formed of a non-conducting material including, but not limited to, polyethylene terephthalate (PET), glass, and polymethyl methacrylate (PMMA). The first conducting touch function layer and the second conducting touch function layer can be formed of the same conducting material or different conductive materials. More specifically, a transparent conducting material used to manufacture the first conducting touch function layer and/or the second conducting touch function layer includes, but is not limited to, indium tin oxide, carbon nanotube, zinc oxide, nanowire, and graphene. Furthermore, in an embodiment the insulating blocks are made of transparent insulating materials, and the touch function circuit takes the form of any shape including, but not limited to, a rectangle, dumbbell, or a funnel.

### EXAMPLE

An example of manufacturing the capacitive touch function structure of the present subject matter is described and illustrated below. The present subject matter is capable of modifications in various obvious aspects, all without departing from the spirit and scope of the present subject matter. The drawings and detailed description are to be regarded as illustrative in nature and not restrictive.

The first conducting touch function layer is fabricated on a non-conducting substrate by, for example, physical vapor deposition or spray coating, followed by etching using a laser or photolithographic technique to form the insulating gap below the disconnected insulating layer, as shown in FIG. 1, and FIG. 2: 6a, 6b, 6c, 6d and 6a′, 6b′, 6c′, 6d′.

Insulating blocks, as shown in FIG. 1, and FIG. 3: 3 and 3′, are manufactured by using for example laser or photolithographic etching on the insulating gap of the first conducting touch function layer, as shown in FIG. 1, and FIG. 5: 6a, 6b, 6c, 6d and 6a′, 6b′, 6c′, 6d′.

The second conducting touch function layer is manufactured on top of the first conducting touch function layer and the insulating blocks, as shown in FIG. 1, FIG. 4, and FIG. 5: 3, 3′, by, for example, physical vapor deposition or spray coating.

Metal leads are deposited by, for example, physical vapor deposition coating or printing, as shown in FIG. 6.

The touch function circuit for the capacitive touch structure disclosed in the present subject matter is manufactured by etching using, e.g. laser or photolithographic method to form the insulating gaps (6a, 6b, 6c, 6d+5a, 5b, 5c, 5d and 6a, 6b′, 6c, 6d′+5a′, 5b′, 5c′, 5d′), as shown in FIGS. 1, 4a, 5, 6, and 7. Furthermore, the insulating gaps are located on the disconnected insulating layer (5a, 5b, 5c, 5d and 5a′, 5b′, 5c′, 5d′) and the metal leads, as shown in FIGS. 1, 4a, 5, 6, and 7.

It should be noted that all figures shown and embodiments disclosed herein are exemplary and should not be viewed as limiting scope of the present subject matter, as depicted in the appended claims.

We claim:

1. A touch function structure for capacitive touch panels comprising:
a first conducting touch function layer formed on a non-conducting substrate and a second conducting touch function layer formed on top of the first conducting touch function layer, wherein the substrate includes a plurality of insulating gaps within the touch function structure;
a plurality of insulating blocks arranged between the first conducting touch function layer and the second conducting touch function layer, wherein the plurality of insulating gaps form a first direction conducting touch function circuit; and
first auxiliary touch function regions formed on the first conducting touch function layer, formed on a second direction conducting touch function circuit, and formed on second auxiliary touch function regions arranged on the second conducting touch function layer.

2. The touch function structure for capacitive touch panels according to claim 1, further comprising:
in a first conducting direction, the plurality of insulating blocks arranged between the second auxiliary touch function regions on the second conductive touch function layer and the first direction touch function circuit.

3. The touch function structure for capacitive touch panels according to claim 1, further comprising:
in a second conducting direction, the plurality of insulating blocks arranged between the first auxiliary touch function regions on the first conductive touch function layer and the second direction touch function circuit.

4. The touch function structure for capacitive touch panels according to claim 1, further comprising:
the plurality of insulating blocks arranged at a plurality of intersection points formed by common areas of the first conducting touch function circuit and the second conducting touch function circuit, wherein the plurality of insulating blocks electrically isolate the first direction conducting touch function circuit from the second direction conducting touch function circuit.

5. The touch function structure for capacitive touch panels according to claim 1, wherein the substrate is formed of a non-conducting material selected from polyethylene terephthalate (PET), glass, and polymethyl methacrylate (PMMA).

6. The touch function structure for capacitive touch panels according to claim 1, wherein the first conducting touch function layer and the second conducting touch function layer are formed of the same conducting material.

7. The touch function structure for capacitive touch panels according to claim 1, wherein the first conducting touch function layer and the second conducting touch function layer are formed of different conducting materials.

8. The touch function structure for capacitive touch panels according to claim 1, wherein the material for manufacturing the first conducting touch function layer and the second conducting touch function layer is a transparent conducting material selected from indium tin oxide, carbon nanotube, zinc oxide, nanowire, and graphene.

9. The touch function structure for capacitive touch panels according to claim 1, wherein the insulating blocks are made of transparent insulating materials.

10. The touch function structure for capacitive touch panels according to claim 1, wherein the touch function circuit is configured to have a geometric shape selected from a rectangle, a dumbbell, and a funnel.
